(19) United States
(12) Patent Application Publication
(10) Pub. No.: US 2021/0094796 A1
(43) Pub. Date: Apr. 1, 2021

(54) Touchless system to be installed for the user control of the elevator based on QR codes and mobile application

(71) Applicants: Faizan Mirza, Irving, TX (US); Hamza Azeez, Plano, TX (US); Parth Behani, Bangalore (IN); Mollie Hamman, Dallas, TX (US); Taifur Rehman, Plano, TX (US); Ayushi Sinha, Plano, TX (US); Aaira Syed, Plainsboro, NJ (US); Mustafa Syed, Murphy, TX (US); Yaseen Syed, Murphy, TX (US); Rizwan Mirza, Patna (IN)

(72) Inventors: Faizan Mirza, Irving, TX (US); Hamza Azeez, Plano, TX (US); Parth Behani, Bangalore (IN); Mollie Hamman, Dallas, TX (US); Taifur Rehman, Plano, TX (US); Ayushi Sinha, Plano, TX (US); Aaira Syed, Plainsboro, NJ (US); Mustafa Syed, Murphy, TX (US); Yaseen Syed, Murphy, TX (US); Rizwan Mirza, Patna (IN)

(73) Assignee: Innowaytors LLC, Irving, TX (US)

(21) Appl. No.: 16/583,448

(22) Filed: Sep. 26, 2019

(51) Int. Cl. B66B 1/46; B66B 1/34; G06F 3/01; G06K 7/14

(52) U.S. Cl. CPC B66B 1/468; B66B 1/3461; G06F 3/017; B66B 2201/4638; B66B 2201/4653; B66B 2201/4615; G06K 7/1417

(57) ABSTRACT

The number of bacteria present on an elevator button is almost 40 times higher than on a public toilet seat. An elevator that requires no physical contact is the answer. Just by the use of the mobile-phone, the transmission of diseases and viruses will be enormously reduced. The first part of the system is the motion sensors on the outside of the elevator, which are used to summon the elevator (up or down). The second part is an app. With the typing of desired floor number, the app generates a QR code which then scan the QR scanner inside the elevator. Lastly there is the Universal Communication Unit which translates the info taken in by the QR scanner and sends it to the operating system for the elevator to then trigger the correct response.

### TECHNICAL FIELD

This system relates to an infrared sensor, such that it is used to detect objects or any physical motion in its view. The mobile application is similar to that of mobile banking app as of Apple Pay which prompts users to use a handheld device that connects to a nearby cash register. The user will then be asked to enter a payment passcode. This relates to the MCU of an elevator because its function is to input and output data that is used to select the floor number.

### BACKGROUND ART

Due to surface contact, elevator buttons carry numerous infectious diseases that could be transmitted from person to person. Touchless elevator control allows the reduction of the spread of disease through touching infected surfaces. Patent (CN104495537) tried to make the elevators faster, smoother, and more reliable rather than trying to make it touchless. The elevator is moved to a floor by scanning a QR code containing identity information and floor information. This is applicable only to specific buildings and makes the QR code specific to each person not making it universal.

Patent (WO2014178790A1) trigger the elevator's control panel to the designated floor (one floor for each device) of the passenger once it has communicated with the mobile device's bluetooth; Additionally the first selection floor system will be the first choice of which floor the passenger will want to go to, by default it is either the ground or first floor. This is not for the ease of use/comfort because the elevator cart will have to stop for every floor making it time consuming. This also have an optional password value which is set to trigger a certain lift with the same password. However, without the correct password the elevator auto selector/activator system will not be triggered. Thus, this application is not viable without a certain initiating call which will not be readily available to all passengers.

This touchless system to be installed for the user control of the elevator based on QR codes and mobile application has a Universal Communication System.

### BRIEF DESCRIPTION OF THE DRAWINGS

FIG. 1 is the sample mobile application (app) where user puts their desired floor number into the app and it generate a QR code, which will then be read by the QR code scanner.

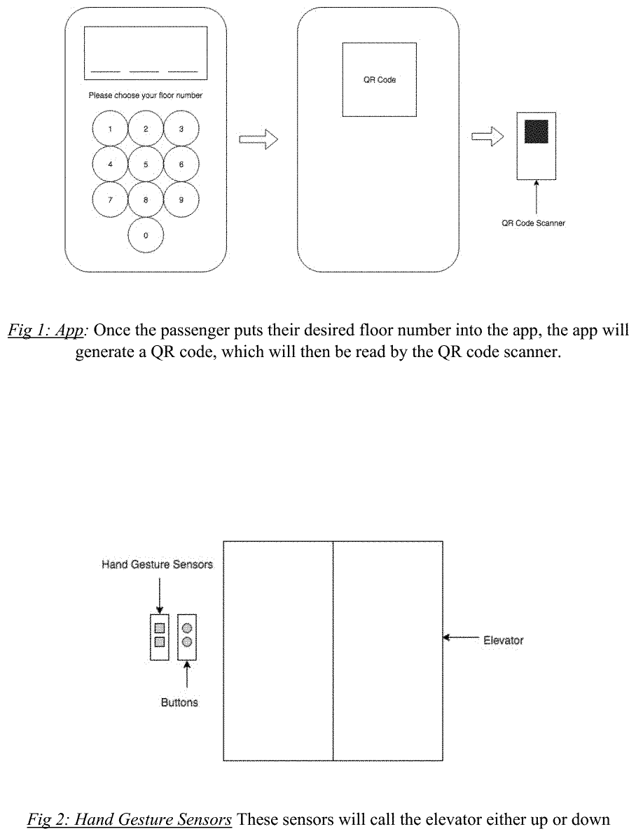

FIG. 2 is the hand gesture sensors which call the elevator either up or down.

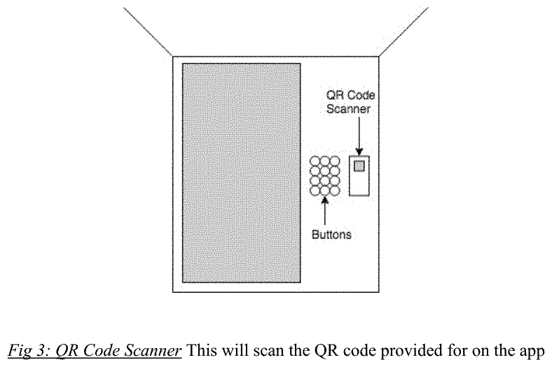

FIG. 3 is the QR code scanner.

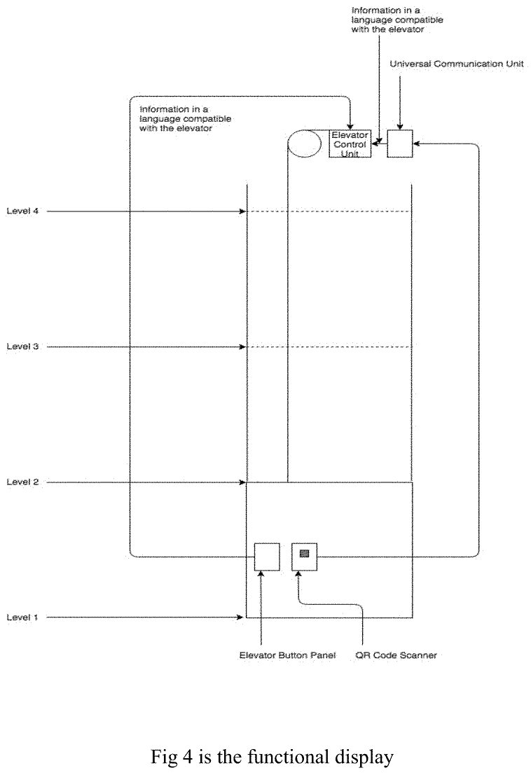

FIG. 4 is the functional display.

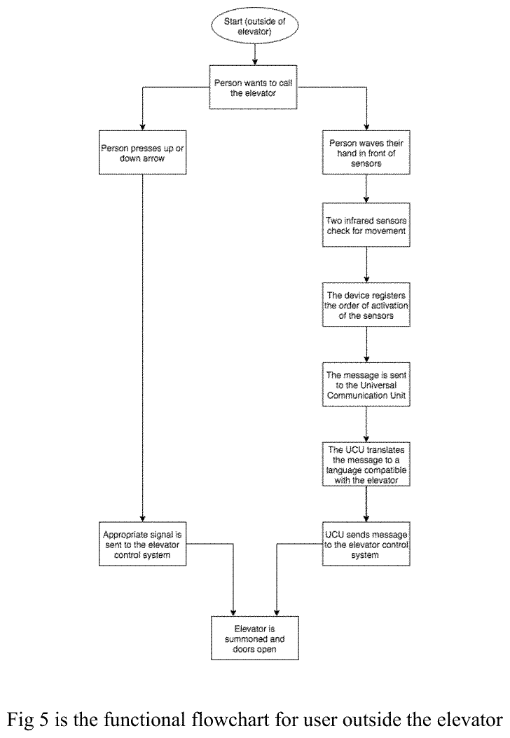

FIG. 5 is the functional flowchart for user outside the elevator.

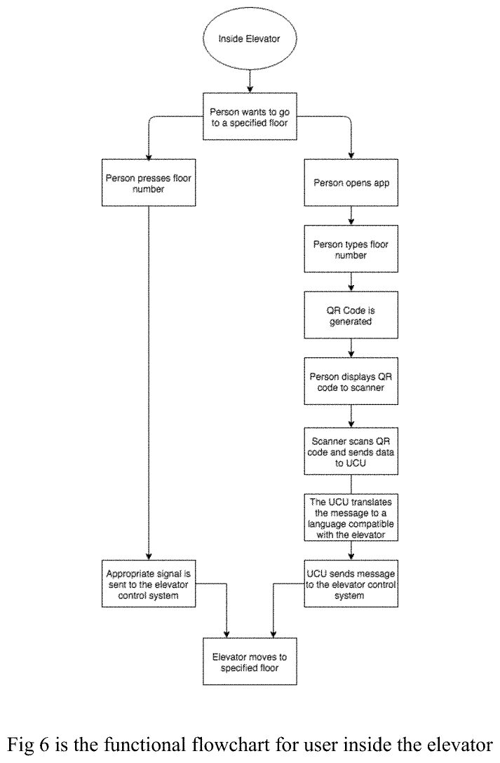

FIG. 6 is the functional flowchart for user inside the elevator.

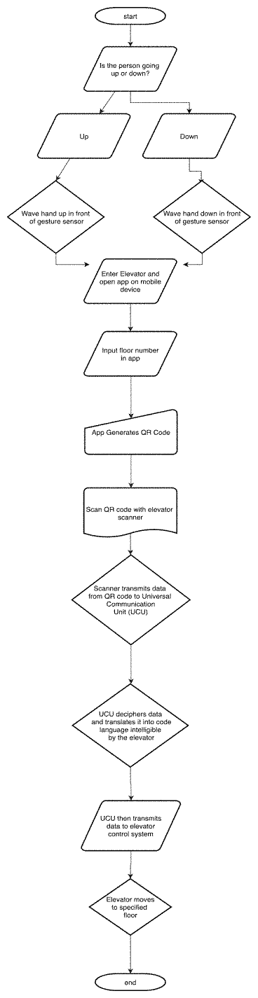

### DETAILED DESCRIPTION

The first section of the system consists of 2 motion sensors, 1 at the top and 1 at the bottom, these go beside the regular buttons outside the elevator for selecting up or down. The motion sensors detect if the individual wants to go up or down by understanding the order in which the sensors are activated. If the individual calls the elevator to go up, they wave their hand upwards, activating the bottom sensor before the top (because the hand passes the bottom one first). If they are swiping their hand downwards, their hand will pass the top sensor first, calling the elevator to go down. This eliminates the spreading of bacteria that comes from touching the outside buttons.

The second part of a system is used by an individual to selects their destination (floor number) without touching any buttons. This consists of 2 parts, a smart phone app and a QR code scanner. In the mobile app, the individual simply enters a floor number, which leads the app to generate a QR code for that specific floor number. Because the app is universal, it can be programmed for any elevator, containing a QR code scanner inside the elevator. The QR code scanner scans the code from the individual's mobile device and sends that information to the Universal Communication Unit (UCU) which then translates it.

The last part of the system is UCU or the Universal Communication Unit which translates the information provided by the QR code scanner and turns it into a language that the original elevator operating system understands. Since this system is universal, it can work for any elevator in the world. Once it translates and sends the information, the elevator triggers the correct response and operates like normal. It doesn't require complex and specific coding and can be used universally for any elevator in the world, and second, it eliminates the transmission and spreading of bacteria and viruses through contacting the elevator buttons.

### Embodiments

Using a number-based system instead of the QR code.
a) Once the user selects a floor on the app, the screen displays that number instead of generating a QR code.
b) On the inside elevator panel, instead of a QR code scanner, there will be a camera with a processing unit. The user then faces his/her phone screen to the camera. The camera captures the phone screen, and the processing unit decodes the number using simple number recognition machine learning and sends the signal to the UCU

User can control this system without having our application installed; he/she could use a notepad app to write the floor number they desire to go to and show the screen to the scanner.

1. A non-contact elevator control system which permits the user to use a swiping gesture to summon the elevator. The swiping gesture control mechanism comprises of two motion sensors lying one on a vertical plane, one above the other and are connected to a programmable device which can register the activation of the aforementioned sensors.

2. A non-contact elevator control system which permits the user to use a QR code to summon an elevator or select a floor post summoning the elevator, with the inner panel of the elevator lies a QR code scanner along with a programmable device that decodes the QR code.

3. The signals after being received by the devices described in claim one and two are sourced through a universal communication unit (UCU) and passed to the elevator system. The UCU converts the signal into a format compatible with the elevator system.
